(19) United States
(12) Patent Application Publication
(10) Pub. No.: US 2012/0211930 A1
(43) Pub. Date: Aug. 23, 2012

(54) MULTI STAGE IMPULSE ABSORBER

(76) Inventors: Ali Bagheri, Gazvin (IR); Akbar Bagheri, Gazvin (IR)

(21) Appl. No.: 13/031,272

(22) Filed: Feb. 21, 2011

(51) Int. Cl. F16F 7/00

(52) U.S. Cl. 267/136

(57) ABSTRACT

The various embodiments herein provide a multistage impulse absorber having an impulse conveying plate attached with an impulse conveying shaft positioned over an impulse absorber main body provided with several guide parts, pins and springs. The impulse conveying shaft has stair like structures so that a received impulse is divided into vertical and horizontal forces by the stair like structures and pins. Several bolts are connected to one end of the springs. The high impulses received by the impulse conveying plate are converted into low impulses along each axis by transferring the high impulses through the impulse conveying shaft. The converted low impulse along each axis is divided into three dimensional impulses based on an optimal gradient surface angle determined in the impulse conveying shaft. The three dimensional impulses are damped by the absorber body using a computing algorithm.

### BACKGROUND

1. Technical field

The embodiments herein generally relate to mechanical shock absorber systems. The embodiments herein particularly relates to an impulse absorber that is capable of converting high impulses into low impulses. The embodiments herein more particularly relates to a multi stage impulse absorbers used in car damper, train tampon, train stopper and train damper systems and in military industry for converting low impulses into three dimensional impulses and damping the total energy within to prevent sustain damages to the impulse absorber.

2. Description of the Related Art

Absorbing impulses and impulsive energy to prevent damages has a long history. At first, the human beings, by the help of soft things like grass, achieved to extend the application time of impulse and decreased the damages. Further, nowadays polymeric material has been used to extend the application time of impulses. The polymeric material used may not qualify enough in case of heavy impulses and may not tackle when very high impulses are received.

In the current scenario, the impulse absorbers need to be operated once again after each stroke and also the impulse absorber must be designed in such a way that it can be activated again automatically for consecutive strokes. Further in the existing technique, the members or parts used for attracting force may not have high returning speed and also the impulse absorbers need manual guidance from a user to direct the slop surfaces and the other pieces correctly.

Hence there is a need for multi-stage impulse absorbers to convert low impulses into three dimensional impulses and to dampen the total energy within to thereby preventing damages to the impulse absorber.

The abovementioned shortcomings, disadvantages and problems are addressed herein and which will be understood by reading and studying the following specification.

### OBJECTS OF THE EMBODIMENTS

The primary object of the embodiments herein is to provide a multi stage impulse absorber for converting the low impulses into three dimensional impulses based on an optimal gradient surface angle and for damping the three dimensional impulses using a computing algorithm.

Yet another object of the embodiments herein is to provide a multi stage impulse absorber that encounters heavy strokes and prevents resulted damages due to the strokes.

These and other objects and advantages of the present invention will become readily apparent from the following detailed description taken in conjunction with the accompanying drawings.

### SUMMARY

The embodiments herein provide a multi stage absorber to encounter heavy strokes and to convert a high impulse into a plurality of low impulses to prevent damages due to the strokes. According to an embodiment herein, a multi stage impulse absorber comprises an impulse conveying plate and an impulse conveying shaft is attached to the impulse conveying plate. An impulse absorber main body is connected to the impulse conveying shaft. A plurality of pins is arranged on the impulse absorber main body. A plurality of springs is coupled respectively to the plurality of pins. A plurality of bolts is attached respectively to the plurality of springs. A plurality of guide parts is connected to the impulse absorber main body. The impulse conveying shaft has a plurality of step like structures to convert a received impulse into vertical and horizontal forces and the converted vertical and horizontal forces are released through the plurality of springs into the impulse absorber main body as a compressed energy of the plurality of the springs.

The absorber main body has a flange connected to a base. The base is a cylindrical sleeve. The guide parts are mounted along a peripheral surface of the cylindrical sleeve to position the impulse conveying shaft in parallel to the absorber main body. The guide parts are arranged at regular intervals along the peripheral surface of the cylindrical sleeve. The guide parts are arranged along the length of the cylindrical sleeve.

An impulse with a higher magnitude received by the impulse conveying plate is converted into a plurality of impulses with lower magnitudes along three axes by transferring the impulse with a higher magnitude through the impulse conveying shaft and wherein the converted impulse with lower magnitude along each said axis is divided into three dimensional impulses based on an optimal gradient surface angle in the impulse conveying shaft and wherein the divided three dimensional impulses are damped by the absorber main body using a computing algorithm.

The optimal gradient surface angle is determined in the impulse conveying shaft based on an allowable tension and a gradient of a force constant of the plurality of the springs.The optimal gradient surface angle is determined by calculating a velocity and a maximum energy for the impulses received at the impulse conveying shaft using a computing algorithm.

The plurality of pins transfers the received impulses to the plurality of the springs. The plurality of the bolts functions as a regulator for the plurality of the springs. The impulse conveying shaft has a high hardness coefficient and gradient surfaces to convert an impulse of higher magnitude into a plurality of impulses with lower magnitudes. The plurality of the guide parts leads the impulse conveying shaft to a default place and direction.

According to an embodiment herein, a multi stage impulse absorber that includes an impulse conveying plate, an impulse conveying shaft and an impulse absorber body. The impulse conveying shaft is attached to the impulse conveying plate. Further the impulse absorber includes one or more springs attached to a plurality of pins. The impulse absorber also includes one or more bolts connected to at least one end of the one or more springs. The impulse absorber body is connected to the impulse conveying shaft with the plurality of pins and the one or more bolts. The impulse absorber also includes one or more guide parts connected to the absorber main body. The high impulses are received by the impulse conveying plate and are converted into low impulses by transferring the high impulses through the impulse conveying shaft. Further, each dimension of the low impulses is divided into three dimensional impulses based on an optimal gradient surface angle determined in the impulse conveying shaft. The three dimensional impulses are damped by the absorber body using a computing algorithm.

The optimal gradient surface angle is determined in the impulse conveying shaft based on an allowable tension and gradient of force constant of the one or more springs. The optimal gradient surface angle is determined by calculating a velocity and a maximum energy for the impulses received using a computing algorithm.

The impulse conveying plate receives the high impulses due to a weight and converts the high impulse into low impulse by transferring through the impulse conveying shaft. The impulse conveying shaft is spiral in shape to divide the low impulses into the three dimensional impulses. The guide parts are connected perpendicularly to the absorber body. The plurality of pins transfers the impulses received to the one or more springs. The bolts function as a regulator for the one or more springs. The impulse absorber includes a base to mount the impulse conveying shaft.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates an exploded perspective view of a multi stage impulse absorber, according to one embodiment herein.

FIG. 2 shows an exemplary graph indicating the operation of a multi stage, according to one embodiment herein.

FIG. 3 shows an exemplary graph indicating the operation of a multi stage, according to another embodiment.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments herein that may be practiced is shown by way of illustration. These embodiments herein are described in sufficient detail to enable those skilled in the art to practice the embodiments herein and it is to be understood that the logical, mechanical and other changes may be made without departing from the scope of the embodiments herein. The following detailed description is therefore not to be taken in a limiting sense.

The embodiments herein provide a multi stage impulse absorber that includes an impulse conveying plate, an impulse conveying shaft and an impulse absorber body. The impulse conveying shaft is attached to the impulse conveying plate. Further the impulse absorber includes one or more springs attached to the plurality of pins. The impulse absorber also includes one or more bolts connected to at least one end of the one or more springs. The impulse absorber body is connected to the impulse conveying shaft with the plurality of pins and the one or more bolts. The impulse absorber also includes one or more guide parts connected to the absorber main body. The high impulses are received by the impulse conveying plate and are converted into low impulses by transferring the high impulses through the impulse conveying shaft. Further each dimension of the low impulses is divided into three dimensional impulses based on an optimal gradient surface angle determined in the impulse conveying shaft. The three dimensional impulses are damped by the absorber body using a computing algorithm.

The optimal gradient surface angle is determined in the impulse conveying shaft based on an allowable tension and gradient of force constant of the one or more springs. The optimal gradient surface angle is determined by calculating a velocity and a maximum energy for the impulses received using a computing algorithm.

The impulse conveying plate receives the high impulses due to a weight and converts the high impulse into low impulse by transferring through the impulse conveying shaft. The impulse conveying shaft is spiral in shape to divide the low impulses into the three dimensional impulses. The guide parts are connected perpendicularly to the absorber body. The plurality of pins transfers the impulses received to the one or more springs. The bolts functions as a regulator for the one or more springs. The multi stage impulse absorber includes a base to mount the impulse conveying shaft.

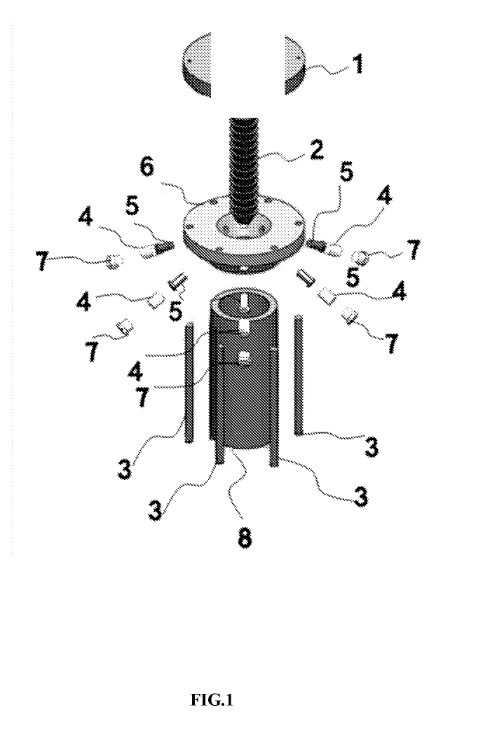

FIG. 1 illustrates an exploded view of an impulse absorber, according to one embodiment herein. The impulse absorber includes an impulse conveying plate 1, an impulse conveying shaft 2, one or more guide parts 3, one or more springs 4, a plurality of pins 5, an impulse absorber body 6, one or more bolts 5, and a base 8. The impulse conveying plate 1 is relatively rigid and transfers the impulse received to the impulse conveying shaft 2. The impulse conveying shaft 2 is designed in the shape of stairs. The received impulses are divided into vertical and horizontal forces by the help of stairs and the plurality of pins. However due to gap between the stairs, the compressed energy of the one or more spring are released in this phase.

The one or more guide parts 3 position the impulse conveying shaft 2 between the impulse conveying plate 1 and the impulse absorber body 6. The one or more springs 4 in the impulse absorber body 6 are responsible for receiving the impulses. The plurality of pins 5 with a gradient contact the stair surface of the impulse conveying shaft 2 to transfer the force to the one or more springs 4.

The impulse absorber body 6 contains the plurality of pins 5, the one or more springs 4 and the one or more bolts 7. The impulse absorber body 6 maintains the plurality of pins 5, the one or more springs 4 and the one or more bolts 7 in the predetermined places and dumps the second arrow stroke which is the result of the impulse direction shift. The one or more bolts 7 in the impulse absorber body 6 acts as a regulator for the one or more springs 4.

The impulse hits the upper part of the impulse conveying plate 2 and the impulse received is transferred to the one or more springs 4 and the plurality of pins 5 through the impulse conveying shaft 2. The impulse conveying shaft 2 is in the form of gradient stairs and transfers the impulse received to the one or more springs 4 and the plurality of pins 5. Further an optimal gradient surface angle is determined for the gradient stairs in the impulse conveying shaft 2. The optimal gradient surface angle is determined in such a way that an angle subtended by the plurality of pins 5 with respect to the horizon is 30 degrees. The optimal gradient surface angle is determined in such a way that the horizontal force exceeds the vertical force and is given by the formula as mentioned below.

F* cos30=Fx.

F* sin30=Fy.

The above mentioned formula implies that due to gradient surface, the required distance for compressing the springs 4 are extended which is effective in the analysis of accident speed and reaction speed of the impulse absorber. The compression of springs 4 and inletting of the plurality of pins 5 in turn results in releasing the impulses by the first stair of the impulse conveying shaft 2. Further while receiving impulse, the one or more springs 4 may not contain potential energy and contain only the neutral energy provided by the impulse conveying shaft 2. The releasing of pins 5 by the saved potential energy in the springs 4 results in the pins 5 returning to their original position.

The impulse acts within the topside of the impulse conveying plate 1 and transmits the impulse to the plurality of pins 5 and consequently to the springs through the impulse conveying shaft 2. The impulses conveying shaft 2 is designed in the form of stairs with the optimal gradient surface angle to 30 degrees. According to the formula mentioned below, the optimal gradient surface angle causes the horizontal force to be more than vertical force so the distance in which the impulse is acting within the apparatus will be increased.

Fx=F* cos30.

Fy=F* sin30.

As the one or more springs 4 are compressed and the plurality of pins 5 is pressed, the impulse conveying shaft 2 quickly enters the apparatus. Further the plurality of pins 5 quickly turns back to the default position.

Consider an example in which the amount of work calculated in the impulse absorber prototype is 200 joules. The amount of energy which is absorbed is related to the force resultant of 6 springs. This force absorbs the energy in a stage and reveals it in the distance between two stairs of the impulse conveying shaft. The amount of work calculated is given above is given by the expression mentioned below.

F=K Δ*X.

Where F=prototype force constant

K=33/0.002=16500F=200/6.

X=2 mm=0.002mΔj33.

XΔ=m0.002.

The total absorbed energy equals sum of 13 areas under curve which is 2500 j.

Saved energy in each spring=33joules

Small pins weight (10 g) m=0.01 kg.

With appropriate designing and tacking the plurality of pins and structure friction, the reaction speed of system is easily analyzed and the achieved velocity (speed) is 81 m/s or 290 km/h using the formula mentioned below.

F=E½=m*v

### Where

F=force constant.

m=mass.

v-velocity.

The reaction speed of the impulse absorber is determined in two ways in the present disclosure. Firstly by the impulse conveying plate that transfers the impulse received to the impulse conveying shaft which is in the shape of stairs. Secondly by the one or more springs and the plurality of pins located in the impulse absorber body to absorb the force.

The impulse equals to velocity over mass, and on the other hand velocity is defined as acceleration over time. The formula to determine impulse is given by the expression below

p=m*(a*t)

But we know that Force=mass (m)* acceleration (a).

Therefore p=f*t

f=p/t.

The relation between force and impulse is clear from the above expression and thereby we can conclude that by increasing the time, the force can be decreased.

P=m*v.

V=a*t.

F=m* a.

The optimal gradient angle varies according to different apparatuses and situations experienced by the impulse absorber. The optimal gradient angle calculated depends on allowable tension and gradient of force constant of the spring. Further the optimal gradient angle is also dependent on the percentage of force absorption of primer cortex.

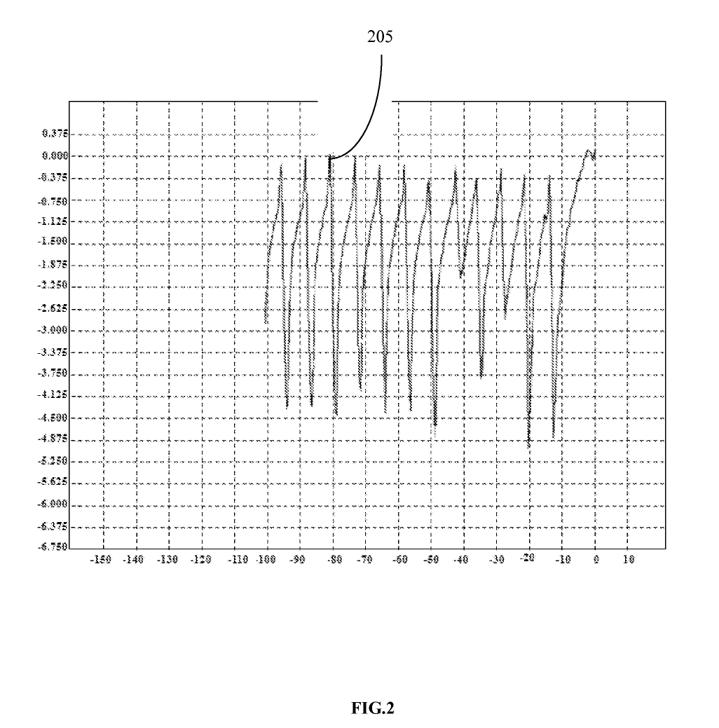

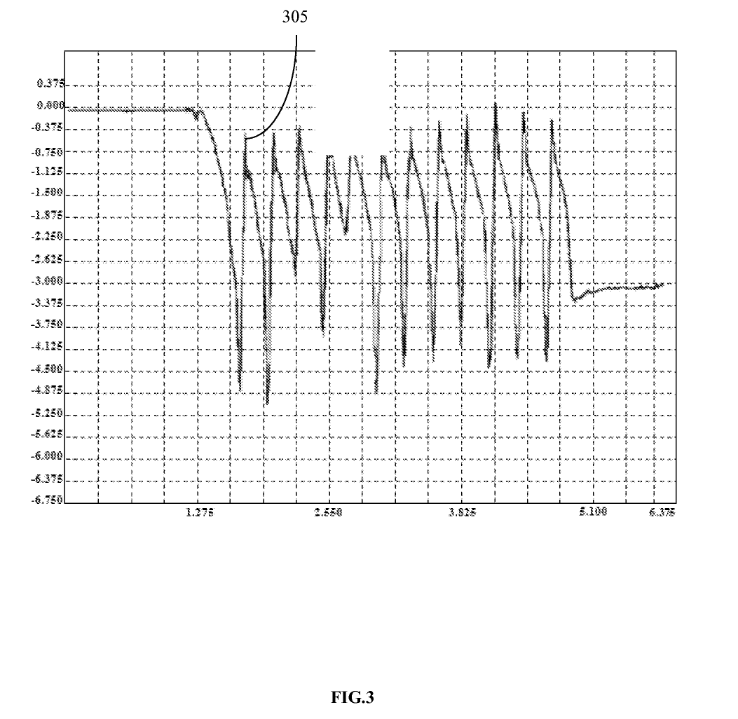

FIG. 2 exemplarily shows a graph indicating the operation of the impulse absorber, according to one embodiment, while FIG. 3 exemplarily shows a graph indicating the operation of the impulse absorber, according to another embodiment. With respect to FIG. 2 and FIG. 3, the graphs 205 and 305 are the archetype of the impulse absorber test. When the impulse hits the upper part of the strike transmission sheet, the force is shifted to the small jags and then to the one or more springs by the impulse conveying shaft that contains embowed stairs. The angles of stairs are designed in such a way that the small jags make a 30 degree angle with the horizontal sheet such that the horizontal force is more than the vertical force and is given by the expression below.

Fx=F*cos30.

Fy=F*sin30.

In other words, the distance required to press the springs is increased because of the sloping surface. Further this is effective in the accurate survey of accidence speed and the reaction speed of the impulse absorber. After pressing the springs and entering the small jags, the first stair is released and the strike transmission shaft enters the system at v2 speed.

The designing algorithm starts from parts list and for each part the surrounding tension calculated. The smallest (weakest) part is considered as calculation basis for cutting force momentarily which omitted in each steps of system.

On the other hand, knowing the type of received impulse and mass, the velocity and the maximum arrived energy is calculated. Having these data, dividing the total amount energy to the amount omitted force in each step determines the number of steps. By calculating the optimal gradient surface angle, the force is further break down into X, Y and Z vector.

The embodiments herein provide an impulse absorber that is used in various applications including car damper, train tampon, train stopper and train damper. Generally it is used in any place where stroke exists the impulse absorber.

The foregoing description of the specific embodiments herein will so fully reveal the general nature of the embodiments herein that others can, by applying current knowledge, readily modify and/or adapt such specific embodiments for various applications without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A multi stage impulse absorber comprising:
an impulse conveying plate;
an impulse conveying shaft attached to the impulse conveying plate;
an impulse absorber main body connected to the impulse conveying shaft;
a plurality of pins arranged on the impulse absorber main body;
a plurality of springs coupled respectively to the plurality of pins;
a plurality of bolts attached respectively to the plurality of springs;
a plurality of guide parts connected to the impulse absorber main body;
Wherein the impulse conveying shaft has a plurality of step like structures to convert a received impulse into vertical and horizontal forces and the converted vertical and horizontal forces are released through the plurality of springs into the impulse absorber main body as a compressed energy of the plurality of the springs.

2. The absorber according to claim 1, wherein the absorber main body has a flange connected to a base.

3. The absorber according to claim 1, wherein the base is a cylindrical sleeve.

4. The absorber according to claim 1, wherein the guide parts are mounted along a peripheral surface of the cylindrical sleeve to position the impulse conveying shaft in parallel to the absorber main body.

5. The absorber according to claim 1, wherein the guide parts are arranged at regular intervals along the peripheral surface of the cylindrical sleeve.

6. The absorber according to claim 1, wherein the guide parts are arranged along the length of the cylindrical sleeve.

7. The absorber according to claim 1, wherein an impulse with a higher magnitude received by the impulse conveying plate is converted into a plurality of impulses with lower magnitudes along three axes by transferring the impulse with a higher magnitude through the impulse conveying shaft and wherein the converted impulse with lower magnitude along each said axis is divided into three dimensional impulses based on an optimal gradient surface angle in the impulse conveying shaft and wherein the divided three dimensional impulses are damped by the absorber main body using a computing algorithm.

8. The impulse absorber according to claim 1, wherein the optimal gradient surface angle is determined in the impulse conveying shaft based on an allowable tension and a gradient of a force constant of the plurality of the springs.

9. The impulse absorber according to claim 1, wherein the optimal gradient surface angle is determined by calculating a velocity and a maximum energy for the impulses received at the impulse conveying shaft using a computing algorithm.

10. The impulse absorber according to claim 1, wherein the plurality of pins transfer the received impulses to the plurality of the springs.

11. The impulse absorber according to claim 1, wherein the plurality of the bolts function as a regulator for the plurality of the springs.

12. The impulse absorber according to claim 1, wherein the impulse conveying shaft has a high hardness coefficient and gradient surfaces to convert an impulse of higher magnitude into a plurality of impulses with lower magnitudes.

13. The impulse absorber according to claim 1, wherein the plurality of the guide parts lead the impulse conveying shaft to a default place and direction.
